(19) United States
(12) Patent Application Publication
(10) Pub. No.: US 2014/0008936 A1
(43) Pub. Date: Jan. 9, 2014

(54) VEHICLE HAVING DUAL FRONT SIDE MEMBER

(71) Applicant: HYUNDAI MOTOR COMPANY, Seoul (KR)

(72) Inventors: Joonam KIM, Yongin-si (KR); Yun Chang Kim, Hwaseong-si (KR)

(73) Assignee: Hyundai Motor Company, Seoul (KR)

(21) Appl. No.: 13/705,831

(22) Filed: Dec. 5, 2012

(30) Foreign Application Priority Data
Jul. 4, 2012 (KR) 10-2012-0073073

(51) Int. Cl. B62D 21/15

(52) U.S. Cl. CPC B62D 21/152
USPC 296/187.09

(57) ABSTRACT

An impact absorption structure having a dual front side member may include a side member of which a side thereof may be fixed on a vehicle body and may be extended to a front side of a vehicle, an auxiliary side member that may be coaxially disposed at a front side of the side member along a longitudinal direction of the vehicle and may be joined with the side member, and a main side member that may be spaced in parallel to the auxiliary side member and of which a rear end portion thereof may be connected to the side member, wherein the main side member may be integrally formed with the side member.

### CROSS-REFERENCE TO RELATED APPLICATION

The present application claims priority to Korean Patent Application No. 10-2012-0073073 filed in the Korean Intellectual Property Office on Jul. 4, 2012, the entire contents of which is incorporated herein for all purposes by this reference.

### BACKGROUND OF THE INVENTION

1. Field of the Invention

The present invention relates to a vehicle having a dual front side member. More particularly, the present invention relates to a vehicle having a dual front side member that reduces overall transformation of a vehicle, protects occupants, and improves stability thereof when a front collision occurs.

2. Description of Related Art

Generally, there are ongoing efforts to properly improve front collision stability of a vehicle, and a desired result has been drawn in a front collision test and a 40% offset collision test.

However, when a front collision of a vehicle similar to a real traffic accident occurs, a collision force cannot be transferred to a front side member across a bumper.

The above case can be realized when a collision does not occur at a part where the front side member is disposed but occurs at another position.

A small overlap test is added as a real test item, and vehicle safety qualification thereby becomes difficult.

When almost all front area of the vehicle is impacted, the front side member absorbs the collision, but when a small (narrow) area thereof is impacted, the front side member cannot absorb the impact and can be bent in a left/right side.

The vehicle body can be excessively transformed by the bend of the front side member and the safety of the occupant cannot be guaranteed.

The information disclosed in this Background of the Invention section is only for enhancement of understanding of the general background of the invention and should not be taken as an acknowledgement or any form of suggestion that this information forms the prior art already known to a person skilled in the art.

### BRIEF SUMMARY

Various aspects of the present invention are directed to providing a vehicle having a dual front side member having advantages of reducing overall transformation of a side member of a vehicle to protect an occupant and improve stability when a front collision of a vehicle occurs.

In an aspect of the present invention, an impact absorption structure having a dual front side member may include a side member of which a side thereof is fixed on a vehicle body and is extended to a front side of a vehicle, an auxiliary side member that is coaxially disposed at a front side of the side member along a longitudinal direction of the vehicle and is joined with the side member, and a main side member that is spaced in parallel to the auxiliary side member and of which a rear end portion thereof is connected to the side member, wherein the main side member is integrally formed with the side member.

One side of the side member is bent to integrally form the main side member.

The auxiliary side member is joined to a first bent surface at which the side member is bent, and a second bent surface that corresponds to the first bent surface of the side member is formed on the auxiliary side member.

The impact absorption structure having the dual front side member may further include a bumper that is spaced at a front side from the main side member and the auxiliary side member.

The impact absorption structure having the dual front side member may further include a crash box that is mounted between the bumper and the main side member and between the bumper and the auxiliary side member to absorb impact.

A crash plate is fixed on a front end portion of the auxiliary side member and the main side member, and the crash box is disposed between the crash plate and the bumper.

The main side member is disposed at an outer side of the vehicle body rather than the auxiliary side member.

The crash box may include a first crash box that is disposed in front of the main side member and connected thereto, and a second crash box that is disposed in front of the auxiliary side member and connected thereto, wherein length of the first crash box is longer than length of the second crash box.

The bumper is shaped convex in a forward direction of the vehicle

As described above, a vehicle having a dual front side member according to an exemplary embodiment of the present invention reduces overall transformation of a side member of a vehicle when a front collision of a vehicle occurs to protect an occupant and improve stability.

Also, collision energy that is transferred from a bumper is distributed to the main side member and the auxiliary side member and therefore a safety condition of an offset collision test and a small overlap collision test can be satisfied.

The methods and apparatuses of the present invention have other features and advantages which will be apparent from or are set forth in more detail in the accompanying drawings, which are incorporated herein, and the following Detailed Description, which together serve to explain certain principles of the present invention.

### BRIEF DESCRIPTION OF THE DRAWINGS

FIG. 1 is an overall top plan view of a vehicle having a dual front side member according to an exemplary embodiment of the present invention.

FIG. 2 is a partial top plan view of a vehicle having a dual front side member according to an exemplary embodiment of the present invention.

FIG. 3 is a perspective view showing an assembling process of a vehicle having a dual front side member according to an exemplary embodiment of the present invention.

FIG. 4 is a partial perspective view of a vehicle having a dual front side member according to an exemplary embodiment of the present invention.

It should be understood that the appended drawings are not necessarily to scale, presenting a somewhat simplified representation of various features illustrative of the basic principles of the invention. The specific design features of the present invention as disclosed herein, including, for example, specific dimensions, orientations, locations, and shapes will be determined in part by the particular intended application and use environment.

In the figures, reference numbers refer to the same or equivalent parts of the present invention throughout the several figures of the drawing.

### DETAILED DESCRIPTION

Reference will now be made in detail to various embodiments of the present invention(s), examples of which are illustrated in the accompanying drawings and described below. While the invention(s) will be described in conjunction with exemplary embodiments, it will be understood that the present description is not intended to limit the invention(s) to those exemplary embodiments. On the contrary, the invention(s) is/are intended to cover not only the exemplary embodiments, but also various alternatives, modifications, equivalents and other embodiments, which may be included within the spirit and scope of the invention as defined by the appended claims.

An exemplary embodiment of the present invention will hereinafter be described in detail with reference to the accompanying drawings.

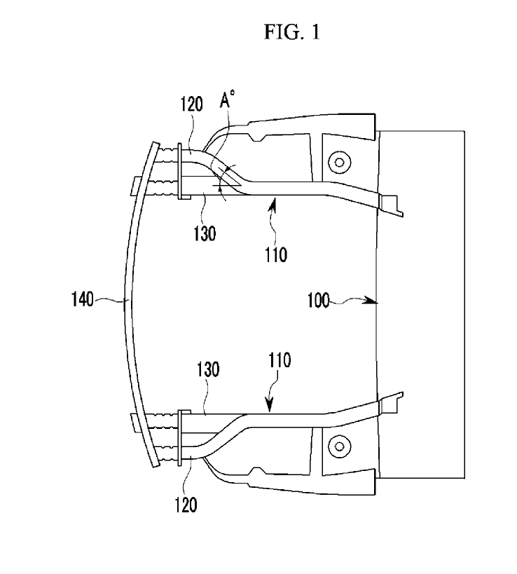

FIG. 1 is an overall top plan view of a vehicle having a dual front side member according to an exemplary embodiment of the present invention.

Referring to FIG. 1, which shows an interior structure of a vehicle, the vehicle include a vehicle body 100, a side member 110, an auxiliary side member 130, a main side member 120, and a bumper 140.

The side member 110 is fixed on the vehicle body 100 and is extended in a front direction of a vehicle, and the auxiliary side member 130 is disposed at a front side of the side member 110 and is disposed on an extended line of the side member 110 to be connected to the side member 110.

Here, the auxiliary side member 130 is coaxially disposed with the side member 110.

The main side member 120 is disposed parallel to the auxiliary side member 130 at a predetermined distance in a width direction. The main side member 120 is integrally formed with the side member 110 in an exemplary embodiment of the present invention.

That is, the main side member 120 that is parallel to the auxiliary side member 130 can be formed by bending the side member 110. The auxiliary side member 130 is joined to the part where the side member 110 is bent in a curve.

The side member 110, the auxiliary side member 130, and the main side member 120 are symmetrically disposed at right/left sides based on the vehicle body 100, and the bumper 140 is disposed at a front side of the auxiliary side member 130 and the main side member 120 at a predetermined distance in an exemplary embodiment of the present invention.

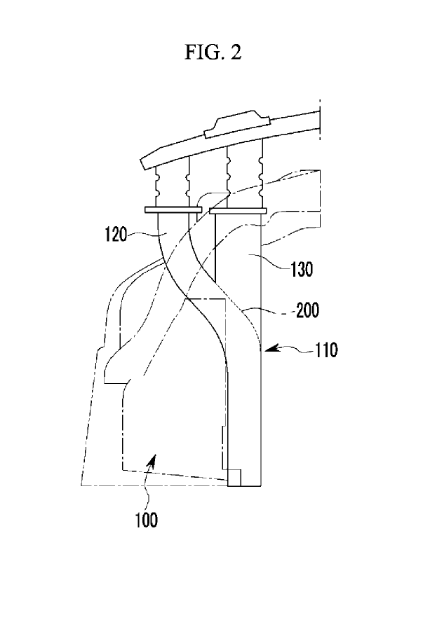

FIG. 2 is a partial top plan view of a vehicle having a dual front side member according to an exemplary embodiment of the present invention.

Referring to FIG. 2, the main side member 120 that is parallel to the auxiliary side member 130 is formed by bending the side member 110 and the auxiliary side member 130 is joined to the part where the side member 110 is bent in a curve, wherein a join surface 200 is formed between the side member 110 and the auxiliary side member 130.

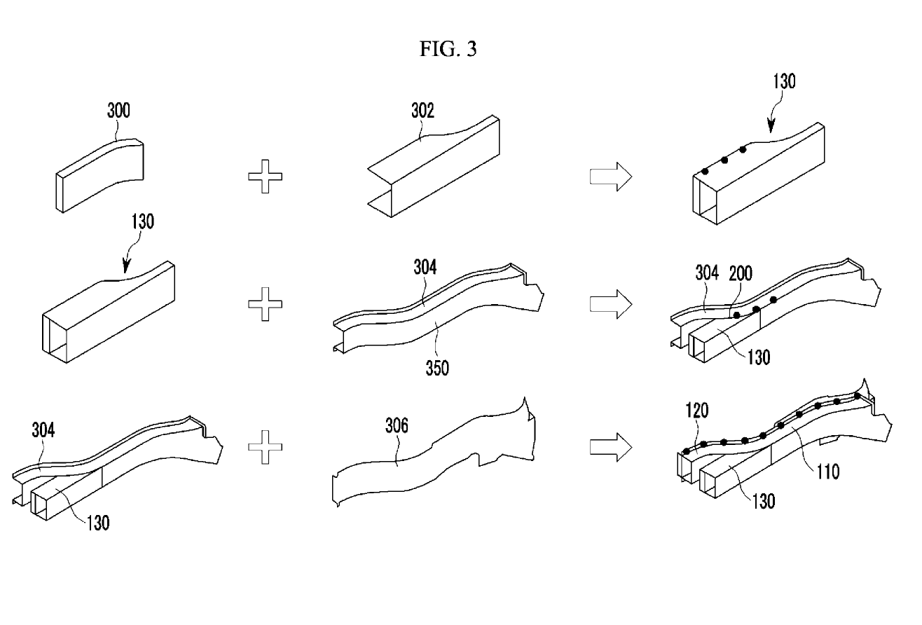

FIG. 3 is a perspective view showing an assembling process of a vehicle having a dual front side member according to an exemplary embodiment of the present invention.

The auxiliary side member 130 is formed by joining a first outer plate 300 with a first inner member 302, and the section of the auxiliary side member 130 has a quadrangular pipe shape.

A second inner member 304 has a bent surface 350 that is formed by bending. Further, the auxiliary side member 130 is formed to correspond to the bent surface 350, and the auxiliary side member 130 is joined to the bent surface 350 of the second inner member 304.

As described above, after the first outer plate 300 and the first inner member 302 are assembled, they are joined to the second inner member 304. Further, a second outer plate 306 is joined to the second inner member 304.

Alternatively, the auxiliary side member 130 can be joined to the side member 110 in a condition that the second outer plate 306 is joined to the second inner member 304.

Here, the joining of the related components can be performed by spot welding, CO₂ welding, or plug welding.

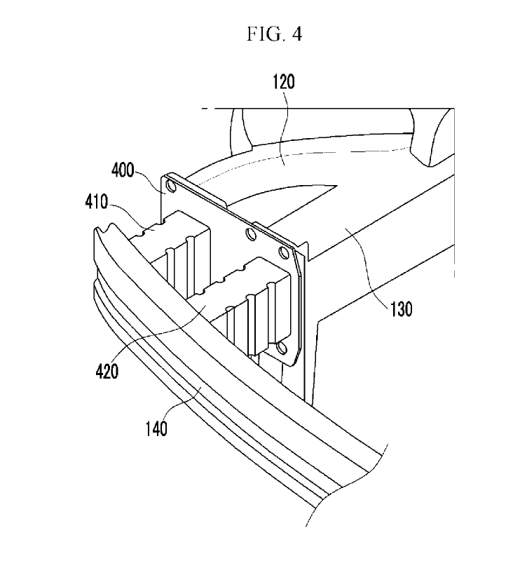

FIG. 4 is a partial perspective view of a vehicle having a dual front side member according to an exemplary embodiment of the present invention.

Referring to FIG. 4, one crash plate 400 is fixed on a front end surface of the main side member 120 and a front end surface of the auxiliary side member 130.

Further, the bumper 140 is disposed at a predetermined distance from the crash plate 400, and a first crash box 410 and a second crash box 420 are disposed between the bumper 140 and the crash plate 400.

The main side member 120 is disposed outside of the vehicle body 100 rather than the auxiliary side member 130, and the second crash box 420 corresponding to the main side member 120 is short and the first crash box 410 corresponding to the auxiliary side member 130 is long.

Here, the first crash box 410 and the second crash box 420 absorb impact energy that is transferred from the vehicle body 100 through the bumper 140.

The side member 110 is coaxially disposed with the auxiliary side member 130, and the auxiliary side member 130 is joined onto the side member 110 in an exemplary embodiment of the present invention. Further, the main side member 120 is formed by bending the side member 110 to integrally form them with each other.

As described above, the main side member 120 and the auxiliary side member 130 are disposed at a distance in a width direction so as to be able to absorb collision energy in a further wider front range.

Accordingly, the side member 110 is not bent in a width direction and the overall transformation of the vehicle is reduced when the front side of the vehicle is impacted so as to protect the occupant and improve stability.

That is, the collision energy that is transferred from the bumper 140 is distributed to the main side member 120 and the auxiliary side member 130, and therefore the safety condition of the offset collision and the small overlap collision test can be satisfied.

Particularly, when the collision is applied to the narrow area that is formed between the main side member 120 and the auxiliary side member 130, the effect is good.

Referring to FIG. 1, an angle (A°) at which the side member 110 is bent based on the auxiliary side member 130 can range from 20 to 60 degrees.

If the angle (A°) becomes larger, the width direction distance between the auxiliary side member 130 and the main side member 120 is increased, and if the angle (A°) becomes smaller, the width direction distance between the auxiliary side member 130 and the main side member 120 is reduced.

For convenience in explanation and accurate definition in the appended claims, the terms “upper”, “lower”, “inner” and “outer” are used to describe features of the exemplary embodiments with reference to the positions of such features as displayed in the figures.

The foregoing descriptions of specific exemplary embodiments of the present invention have been presented for purposes of illustration and description. They are not intended to be exhaustive or to limit the invention to the precise forms disclosed, and obviously many modifications and variations are possible in light of the above teachings. The exemplary embodiments were chosen and described in order to explain certain principles of the invention and their practical application, to thereby enable others skilled in the art to make and utilize various exemplary embodiments of the present invention, as well as various alternatives and modifications thereof. It is intended that the scope of the invention be defined by the Claims appended hereto and their equivalents.

What is claimed is:

1. An impact absorption structure having a dual front side member, comprising:
a side member of which a side thereof is fixed on a vehicle body and is extended to a front side of a vehicle;
an auxiliary side member that is coaxially disposed at a front side of the side member along a longitudinal direction of the vehicle and is joined with the side member; and
a main side member that is spaced in parallel to the auxiliary side member and of which a rear end portion thereof is connected to the side member,
wherein the main side member is integrally formed with the side member.

2. The impact absorption structure having the dual front side member of claim 1, wherein one side of the side member is bent to integrally form the main side member.

3. The impact absorption structure having the dual front side member of claim 2,
wherein the auxiliary side member is joined to a first bent surface at which the side member is bent, and
wherein a second bent surface that corresponds to the first bent surface of the side member is formed on the auxiliary side member.

4. The impact absorption structure having the dual front side member of claim 1, further comprising a bumper that is spaced at a front side from the main side member and the auxiliary side member.

5. The impact absorption structure having the dual front side member of claim 4, further comprising a crash box that is mounted between the bumper and the main side member and between the bumper and the auxiliary side member to absorb impact.

6. The impact absorption structure having the dual front side member of claim 5,
wherein a crash plate is fixed on a front end portion of the auxiliary side member and the main side member, and
wherein the crash box is disposed between the crash plate and the bumper.

7. The impact absorption structure having the dual front side member of claim 6, wherein the main side member is disposed at an outer side of the vehicle body rather than the auxiliary side member.

8. The impact absorption structure having the dual front side member of claim 6, wherein the crash box includes:
a first crash box that is disposed in front of the main side member and connected thereto; and
a second crash box that is disposed in front of the auxiliary side member and connected thereto,
wherein length of the first crash box is longer than length of the second crash box.

9. The impact absorption structure having the dual front side member of claim 4, wherein the bumper is shaped convex in a forward direction of the vehicle.
